(19) United States
(12) Patent Application Publication
(10) Pub. No.: US 2012/0175429 A1
(43) Pub. Date: Jul. 12, 2012

(54) FLUID DISPENSER AND PROCESSES THEREOF

(76) Inventor: Matthew M. Zupsic, Fort Myers Beach, FL (US)

(21) Appl. No.: 13/343,193

(22) Filed: Jan. 4, 2012

Related U.S. Application Data
(60) Provisional application No. 61/430,219, filed on Jan. 6, 2011.

(51) Int. Cl. B05B 9/08; B05B 15/00; B05B 7/24

(52) U.S. Cl. 239/8; 239/154; 239/307

(57) ABSTRACT

A device may include one or more fluid containers, compressor vessels and/or conduit systems. A fluid container may be configured to house a fluid, for example an incompressible fluid, and/or may include one or more bags. A compressor vessel configured to fluidly connect one or more fluid containers, and/or house a fluid, for example a compressible fluid. A conduit system may include one or more fluid lines. A fluid line may be configured to fluidly connect to one or more fluid containers, and/or include an outlet portion. Fluid housed in a fluid container may be actuated through a fluid line and out of an outlet portion thereof by a force supplied by a compressible fluid. A process may include dispensing and/or applying one or more fluids to a subject. A process may include selecting and/or adjusting a fluid. A process may include processing one or more factors.

This application claims the benefit of U.S. Provisional Application No. 61/430,219, filed on Jan. 6, 2011, which is hereby incorporated by reference in its entirety.

### BACKGROUND

Embodiments may relate to fluid dispensers and/or processes thereof. Some embodiments may relate to a portable fluid dispenser, for example a portable skin fluid dispenser, and processes of operating a portable fluid dispenser.

A fluid dispenser may mix fluids in a container and/or in multiple fluid lines of a fluid pathway. A fluid dispenser may pulse fluids in a fluid line and/or may mix pulsed fluid with air injected in the path of the pulsed fluid. However, excessive mixing and/or pulsing may minimize the integrity of housed fluids and/or the active properties of applied fluids.

A fluid dispenser configured to house two or more fluids may be portable. However, a portable fluid dispenser may not be configured to be carried and/or may not be configured to be simultaneously carried and operated. A portable fluid dispenser may not be configured to be practically moved and/or practically moved and operated irrespective of the environment of operation, for example irrespective of terrain. However, an inability to carry and/or simultaneously carry and operate a portable fluid dispenser may limit it's operation.

### SUMMARY

Embodiments may relate to a fluid dispensing apparatus. In some aspects of embodiments, a fluid dispenser may include one or more containers, one or more compressor vessels and/or one or more conduit systems. In one aspect of embodiments, a fluid container may be configured to house a fluid, which may include an incompressible fluid. In embodiments, an incompressible fluid may include a liquid, for example sunscreen, sun block bronzer and/or artificial tanner. In another aspect of embodiments, a compressor vessel may be configured to house a fluid, for example a compressible fluid that may be compressed. In embodiments, a compressible fluid may include a gas, for example air and/or the like.

According to some aspects of embodiments, a fluid container may include a bag. In one aspect of embodiments, a bag may include any suitable material, for example a polymer material such as plastic. In another aspects of embodiments, a plastic bag may include a medical grade plastic bag, food grade plastic bag and/or the like. In further aspects of embodiments, a fluid container may include a canister. In other aspects of embodiments, a canister may include any suitable material, for example aluminum, polymer, ceramic, composite and/or the like. In more aspects of embodiments, a canister may include any shape, for example the approximate shape of a cylinder, and/or geometry.

According to some aspects of embodiments, a compressor vessel may be configured to fluidly connect one or more fluid containers. In one aspect of embodiments, a compressor vessel may include any suitable vessel, for example a pressure tank. In another aspect of embodiments, a compressor vessel may include a receiver vessel of a compressor. In further aspects of embodiments, a compressor may include a portable gas compressor. In other aspects of embodiments, a compressor may include an electrically powered portable gas compressor.

According to some aspects of embodiments, a conduit system may be configured to fluidly connect to one or more fluid containers. In some aspects of embodiments, a conduit system may include one or more fluid lines. In one aspect of embodiments, each fluid line of a conduit system may be configured to fluidly connect one or more fluid containers. In another aspect of embodiments, each fluid line of a conduit system may include one or more outlet portions. In further aspects of embodiments, an outlet portion of a fluid line may be isolated, unconnected, disconnected, spaced apart and/or detached from an outlet portion of another fluid line. In other aspects of embodiments, a conduit system and/or portion thereof may be reversibly mechanically releasable. In more aspects of embodiments, a conduit system and/or portion thereof may be disposed in a housing, for example a flexible line housing, a dispensing housing and/or the like.

According to some aspects of embodiments, a fluid dispenser may include one or more applicators. In one aspect of embodiments, an applicator may include one or more output fluid lines. In another aspect of embodiments, an output fluid line may be configured to be in direct fluid communication with an outlet portion of a fluid line. In further aspects of embodiments, a single output fluid line may be configured to be in direct fluid communication with an outlet portion of each fluid line of a conduit system.

According to some aspects of embodiments, an applicator may include an adjustable applicator. In one aspect of embodiments, an applicator may be adjustable in the radial direction, for example to align with an outlet portion and/or adjust fluid flow rate. In another aspect of embodiments, an applicator may be adjustable in any axis, for a Cartesian axis example relative to a user. In further aspects of embodiments, an adjustable applicator may include a spray nozzle. In other aspects of embodiments, an applicator may be configured to be fluidly connected to an outlet portion of a fluid line. In more aspects of embodiments, a output fluid line of an applicator may be disposed in a spray nozzle and/or may be connected to a sprayer tip. In embodiments, a fluid line may be in fluid communication with a corresponding isolated output fluid line, orifice of a spray nozzle, sprayer tip and/or the like.

According to some aspects of embodiments, a fluid dispenser may include one or more control systems. In one aspect of embodiments, a control system may be configured to control the flow of a fluid through a fluid line. In another aspect of embodiments, a control system may be disposed on a housing, for example a dispensing housing. In further aspects of embodiments, a control system may include a mechanical and/or electrical control system. In other aspects of embodiments, an operator may employ a control system to select and/or allow the flow of fluid employing a push-button control.

According to some aspects of embodiments, a fluid may be forced, moved and/or actuated through a fluid line of a conduit system by a compressible fluid. In one aspect of embodiments, a fluid may be pressurized by a compressible fluid. In another aspect of embodiments, a fluid may be actuated through a fluid line by a force supplied by a compressible fluid, for example a substantially constant force. In further aspects of embodiments, a fluid may be actuated and/or pressurized by any suitable pressure, for example employing a pressure of approximately 25 psi supplied by a compressible fluid.

According to some aspects of embodiments, a fluid actuated and/or discharged may exhibit any flow rate, for example substantially constant flow rate, substantially adiabatic modulating flow rate, substantially unpulsed flow rate and/or the like. In some aspects of embodiments, a fluid may be substantially unmixed prior to dispensing from a fluid dispenser. In one aspect of embodiments, a pressurized fluid may not be mixed with a gas injected in a fluid line of a conduit system. In another aspect of embodiments, a fluid may be substantially unmixed with other fluids housed in a dispensing apparatus, for example with another fluid housed in another container of the dispensing apparatus.

According to some aspects of embodiments, a fluid container, compressor vessel, conduit system, applicator, control system and/or portion thereof may be reversibly mechanically releasable. In one aspects of embodiments, any suitable connection may employed to connect one or more fluid containers, compressor vessels, compressors, conduit systems, applicators, control systems, portions thereof and/or the like, for example to each other in any configuration. In another aspects of embodiments, a connection may include a mechanical connection, chemical connection, magnetic connection, electrical connection and/or the like. In further aspects of embodiments, a connection may include a connector, such as a threaded connector, rail connector, snap connector, adhesive, magnet and/or the like. In embodiments, for example, a reversibly mechanically releasable fluid container may be exchanged and/or re-filled without substantially damaging a fluid dispenser and/or impacting it's efficiency.

According to some aspects of embodiments, a fluid dispenser may be configured to be carried by an operator. In one aspect of embodiments, a fluid dispenser may include one or more straps, for example a shoulder strap, a waist strap and/or the like. In another aspect of embodiments, a fluid dispenser may include a frame, a bench and/or the like. In further aspects of embodiments, a fluid dispenser may be configured to be simultaneously carried and employed by an operator. In another aspects of embodiments, a portable fluid dispenser may be configured to be practically moved and/or practically simultaneously moved and employed irrespective of the environment of operation, for example irrespective of terrain. In embodiments, a fluid dispenser may not require wheels.

Embodiments may relate to processes of employing a fluid dispenser. In one aspect of embodiments, a process may include dispensing and/or applying one or more fluids to a subject. In, another aspect of embodiments, a process may include applying one or more incompressible fluids to a subject. In further aspects of embodiments, a subject may include a human, a device, a rural structure, an urban structure, portions thereof and/or the like. In other aspects of embodiments, a process may include dispensing and/or applying a fluid in a real-time manner, at the point of fluid use and/or fluid need, and/or the like.

According to some aspects of embodiments, a process may include selecting one or more fluids for discharge and/or application. In one aspect of embodiments, a process may include adjusting a fluid, which may include during application. In another aspect of embodiments, adjustment of a fluid may include regulating flow rate, regulating the amount pressure supplied to the fluid, regulating pulsing of fluid flow, adjusting an applicator and/or the like. In further aspects of embodiments, selecting and/or adjusting a fluid may include processing one or more factors. In other aspects of embodiments, processing a factor may include employing a computer processor. In more aspects of embodiments, a factor may include Sun Protection Factor (SPF), skin tone preference, prior sun damage, risk of subsequent burn damage, cost, water resistance, time of day, skin type, amount of fluid applied, frequency of application, user activities, and/or amount of fluid absorbed on the skin.

### DRAWINGS

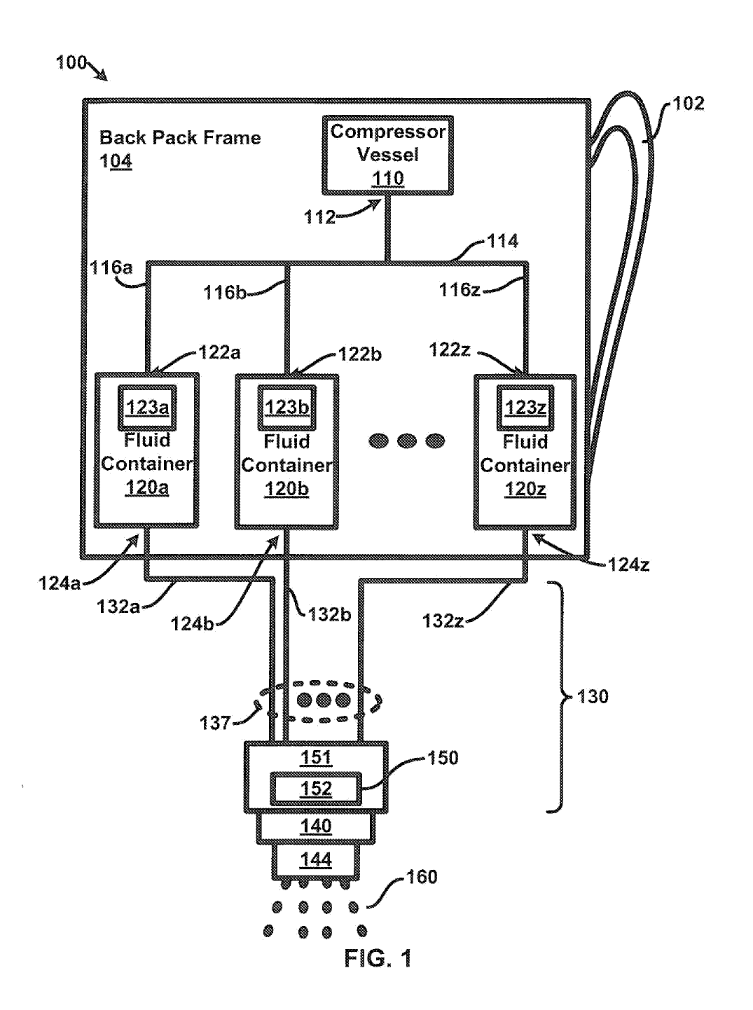

Example FIG. 1 illustrates a fluid dispenser in accordance with some aspects of embodiments.

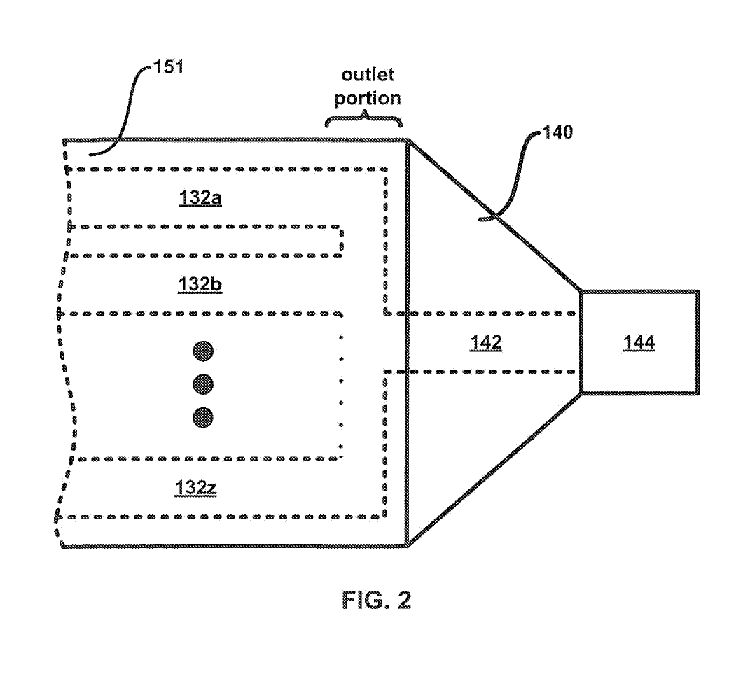

Example FIG. 2 illustrates a portion of a conduit system in fluid communication with a portion of an applicator in accordance with some aspects of embodiments.

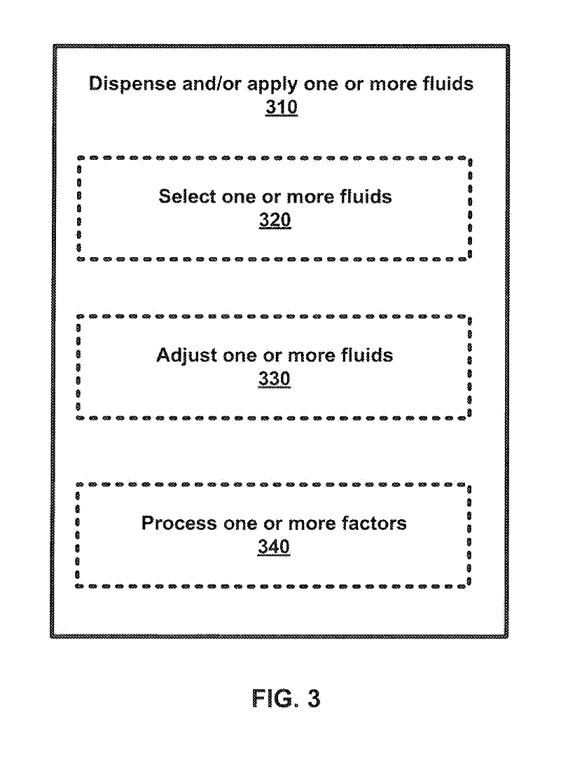

Example FIG. 3 illustrates a process of dispensing and/or applying a fluid in accordance with some aspects of embodiments.

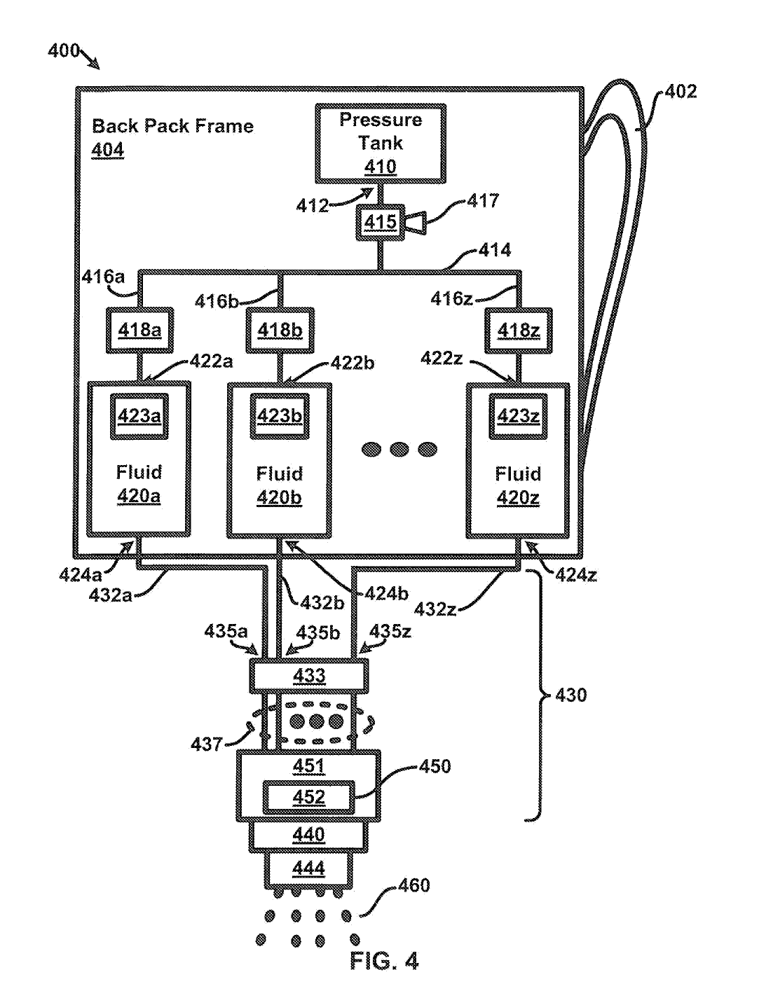

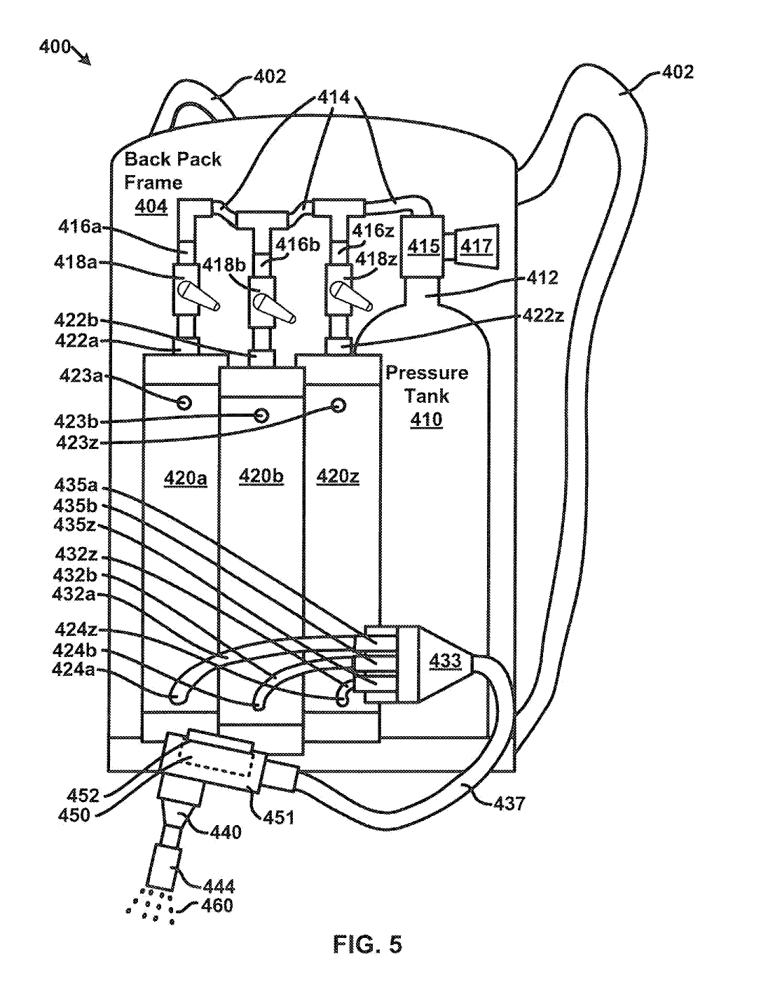

Examples FIG. 4 and FIG. 5 illustrate a fluid dispenser in accordance with some aspects of embodiments.

### DESCRIPTION

Embodiments may relate to a fluid dispensing apparatus. Referring to example FIG. 1, a fluid dispenser is illustrated in accordance with some aspects of embodiments. In some aspects of embodiments, fluid dispenser 100 may include compressor vessel 110. In one aspect of embodiments, compressor vessel 110 may be configured to house a fluid. In one aspect of embodiments, a fluid may include a compressible fluid. In another aspect of embodiments, a compressible fluid may be compressed. In further aspects of embodiments, a compressible fluid may include a gas, for example air, oxygen, nitrogen and/or the like.

According to some aspects of embodiments, a compressor vessel may include any suitable vessel. In one aspect of embodiments, a compressor vessel may include a pressure tank, for example a diving tank. In embodiments, a pressure tank may be unconnected to a compressor. In another aspect of embodiments, a compressor vessel may include a receiver vessel of a compressor, for example a receiver vessel of a portable gas compressor. In embodiments, a receiver vessel may be connected to a portable gas compressor. In further aspects of embodiments, a portable gas compressor may include an electrically powered portable gas compressor, for example a battery-powered gas compressor. In more aspects of embodiments, a compressor vessel may include an adjustable pressure regulator which may be configured to adjust discharge pressure. In embodiments, a pressure regulator may include a visual display, for example a pressure gauge, a digital pressure gauge and/or the like.

Referring back to FIG. 1, fluid dispenser 100 may include fluid containers 120a, 120b, . . . 120z. In some aspects of embodiments, compressor vessel 110 may be configured to fluidly connect with fluid containers 120a, 120b, . . . 120z. In one aspect of embodiments, a compressor vessel may include one or more pressure output ports connected to one or more pressure lines, which may be connected to one or more pressure input ports of one or more fluid containers. In another aspect of embodiments, a pressure line may include a common pressure line and/or may be directly isolatedly connected with a compressor vessel. In further aspects of embodiments, a pressure line may include one or more pressure line valves which may be configured to modulate flow of compressed fluid, for example from a compressor vessel to a fluid container. As illustrated in some aspects of embodiments in FIG. 1, pressure lines 116a, 116b, . . . 116z may be connected to pressure output port 112 of compressor vessel 110 at one end, for example employing common pressure line 114. As illustrated in other aspect of embodiments in FIG. 1, pressure lines 116a, 116b, . . . 116z may be connected to pressure input ports 122a, 122b, . . . 122z of respective fluid containers 120a, 120b, . . . 120z at the other end.

According to some aspects of embodiments, fluid containers 120a, 120b, . . . 120z may be configured to house a fluid. In embodiments, fluid containers 120a, 120b, . . . 120z may include the same and/or different fluids. In one aspect of embodiments, a fluid may include an incompressible fluid. In another aspect of embodiments, an incompressible fluid may include any liquid. In further aspects of embodiments, a liquid may include a topical product, cleaning solution, paint, pesticide and/or the like. In other aspects of embodiments, a topical product may include sunscreen, sunblock, bronzer, artificial tanner, moisturizer, gel, lotion and/or the like. In more aspects of embodiments, a topical product may adsorb and/or reflect ultraviolet (UV) radiation on a user's skin, which may be exposed to sunlight. In embodiments, a topical product may enhance effects of UV radiation on skin, for example by including ingredients that may promote the production of melanin on the skin and/or maximize blood flow to the skin. In embodiments, a topical product may modulate skin tone.

According to some aspect of embodiments, a fluid container may include a bag. In one aspect of embodiments, a bag may include any suitable material, for example a polymer material such as plastic. In another aspect of embodiments, a plastic bag may include a medical grade plastic bag; food grade plastic bag and/or the like. In further aspects of embodiments, a bag may include a medical intravenous plastic bag.

According to some aspects of embodiments, a plastic bag may include a quick disconnect adapter, for example a male and/or female quick disconnect adapter. In another aspect of embodiments, a bag may maximize fluid capacity, ease of handling, integrity and/or the like. In further aspects of embodiments, a fluid container, for example a bag, may include a perforated portion which may operate to provide access to a fluid and/or a portion of the container when punctured. In more aspects of embodiments, a perforated portion may be punctured by a mating connector, for example of a fluid line, a refill device and/or the like. In embodiments, a mating connector may include a threaded connection, such that mating corresponding threaded connectors may puncture a perforated portion.

According to some aspects of embodiments, a fluid container may include a canister. In one aspect of embodiments, a canister may include any suitable material, for example aluminum, polymer, ceramic, composite and/or the like. In another aspect of embodiments, a canister may include any shape, for example the approximate shape of a cylinder, square, rectangle, amorphous shape and/or the like. In further aspects of embodiments, a canister may include any dimension, for example volume, mass, length, width height and/or the like. In further aspects of embodiments, a bag may be disposed in a canister and/or may be separate from a canister. As illustrated in some aspects of embodiments in FIG. 1, fluid containers 120, 120b, . . . 120c may include a bag and/or a canister.

According to some aspects of embodiments, fluid dispenser 100 may include conduit system 130. In some aspects of embodiments, conduit system 130 may be configured to fluidly connect to fluid containers 120a, 120b, . . . 120z. In one aspect of embodiments, each fluid line of a conduit system may be configured to fluidly connect to one or more fluid containers. In another aspect of embodiments, a fluid container may include one or more pressurized fluid output ports connected to one or more fluid lines, which may include one or more outlet portions. As illustrated in some aspects of embodiments in FIG. 1, each fluid line 132a, 132b, . . . 132z of conduit system 130 may be configured to fluidly connect to corresponding pressurized fluid output ports 124a, 124b . . . 124z of respective fluid containers 120a, 120b, . . . 120z.

Referring to example. FIG. 2, a portion of a conduit system of a fluid dispenser is illustrated in accordance with some aspects of embodiments. In one aspect of embodiments, a fluid line and/or portion thereof may be isolated, unconnected, disconnected, spaced apart and/or detached from an outlet portion of another fluid line, although physically grouped together. In one aspect of embodiments, each fluid line may extend from a single pressurized fluid output port of a fluid container to an outlet portion thereof. Referring back to some aspects of embodiments illustrated in FIG. 1, each fluid line 132a, 132b, . . . 132z may extend between a single pressurized fluid output port 124a, 124b, . . . 124z of a fluid. containers 120a, 120b, . . . 120z and an outlet portion thereof.

According to some aspects of embodiments, an uncompressed fluid may be forced, moved and/or actuated through a fluid line of a conduit system by a compressed fluid. In one aspect of embodiments, a fluid may be pressurized by a compressible fluid. In another aspect of embodiments, a fluid may be actuated through a fluid line by a force supplied by a fluid, for example a substantially constant force. In further aspects of embodiments, a fluid may be actuated and/or pressurized by any suitable pressure, for example employing a pressure of approximately 25 psi supplied by a compressed fluid. Referring back to some aspects of embodiments in FIG. 1, a fluid housed in fluid containers 120a, 120b, . . . 120z, which may be pressurized by the fluid housed in compressor vessel 110, and/or may be actuated through fluid lines 132a, 132b . . . 132z by the force supplied by a fluid housed in compressor vessel 110.

According to some aspects of embodiments, a fluid actuated and/or discharged may exhibit any flow rate, for example substantially constant flow rate, substantially adiabatic modulating flow rate, substantially unpulsed flow rate and/or the like. In one aspect of embodiments, a substantially constant flow rate may be provided through an open fluid line. In another aspect of embodiments, discharged fluid flow may be pulsed by opening and closing a fluid line although the flow rate in an open fluid line may be substantially constant. In further aspects of embodiments, a substantially adiabatic modulating flow rate may include an increasing adiabatic flow rate and/or an decreeing adiabatic flow rate. In other aspects of embodiments, for example in a skin fluid dispenser, a relatively low flow rate of topical fluid may begin at coverable body parts and adiabatically increase as fluid is applied to body parts that may remain uncovered and/or exposed to UV radiation.

According to some aspects of embodiments, a fluid may be substantially unmixed prior to dispensing from a fluid dispenser. In one aspect of embodiments, a pressurized fluid may not be mixed with a gas injected in a fluid line of a conduit system. In another aspect of embodiments, a fluid may be substantially unmixed with other fluids housed in a dispensing apparatus, for example with another fluid housed in another container of a dispensing apparatus. As illustrated in some aspects of embodiments in FIG. 1, fluids traveling in fluid lines 132a, 132b, . . . 132z may be substantially unmixed with each other, thereby maximizing the integrity of fluids housed in fluid containers 120a, 120b, . . . 120z and/or the active properties of a fluid.

According to some aspects of embodiments, fluid dispenser 100 may include one or more applicators 140. In one aspect of embodiments, an applicator may include one or more output fluid lines. In another aspect of embodiments, an output fluid line may be configured to be in direct fluid communication with an outlet portion of a fluid line. In further aspects of embodiments, a single output fluid line may be configured to be in direct and/or isolated fluid communication with an outlet portion of each fluid line of a conduit system. As illustrated in some aspects of FIG. 2, output fluid line 142 may be configured to be in direct fluid communication with an outlet portion of each fluid line 132a, 132b, . . . 132z of conduit system 130.

According to some aspects of embodiments, a portion of a conduit system may be connected with an applicator. In one aspect of embodiments, an applicator may be connected to an outlet portion of a fluid line. In another aspects of embodiments, a portion of a conduit. system may be disposed in a housing, for example a dispensing head. In further aspects of embodiments, a dispensing head may he connected to an applicator. As illustrated in some aspects of embodiments in FIG. 1 and FIG. 2, a portion of fluid lines 132a, 132b, . . . 132z may be disposed in housing 151, which may be connected to applicator 140 and/or fluid outlet portion 142.

According to some aspects of embodiments, applicator 140 may include a spray nozzle. In one aspect of embodiments, an output fluid line of an applicator may be disposed in a spray nozzle. In another aspect of embodiments, an output fluid line of an applicator may be connected with a sprayer tip. In further aspects of embodiments, two or more isolated output fluid lines and/or sprayer tips may be bundled in the same nozzle housing and/or may be configured to be in register with corresponding fluid lines. As illustrated on some aspect of embodiment in example FIG. 2, spray nozzle 140 may include output fluid line 142, which may he connected to sprayer tip 144 at one end and in direct fluid communication with fluid lines 132a, 132b, . . . 132z at the other end.

According to some aspects of embodiments, a portion of a conduit system and/or of an applicator may be adjustable. In one aspect of embodiments, a portion of a conduit system and/or an applicator may be adjustable in any radial and/or Cartesian axis, such as in X, Y and/or Z Cartesian coordinate relative to a user. In another aspect of embodiments, a portion of a conduit system and/or an applicator may be adjustable irrespective of each other. In further aspects of embodiments, an applicator and/or portion thereof may be adjustable, for example in the radial direction to align an output fluid line with an outlet portion and/or to adjust fluid flow rate, irrespective of the motion of a conduit system. In other aspects of embodiments, an applicator and/or portion thereof may be adjustable, for example in the X-Y-Z plane direction to align with a surface, irrespective of the motion of a conduit system. Referring to some aspects of embodiments in FIG. 1, a portion of conduit system 130 and/or applicator 140 may each be independently adjustable.

According to some aspects of embodiments, fluid dispenser 100 may include control system 150. In one aspect of embodiments, a control system may be configured to control the flow of a fluid through a fluid line. In another aspect of embodiments, a control system may be disposed on a housing, for example on a dispensing head. In further aspects of embodiments, a control system may include a mechanical and/or electrical control system. In other aspects of embodiments, an operator may employ the control system to select and/or allow the flow of fluid by employing a push-button control. As illustrated in some aspects of embodiments in FIG. 1, control system 150 may be disposed on dispensing head 151 and/or may include one or more push-button controls 152, which may select and/or allow the flow of fluid from fluid lines 132a, 132b, . . . 132z.

According to some aspects of embodiments, any suitable connection may employed to connect one or more fluid containers, compressor vessels, compressors, conduit systems, applicators, control systems and/or portions thereof, for example to each other. In one aspect of embodiments, a connection may include a mechanical connection, chemical connection, magnetic connection, electrical connection and/or the like. In another aspect of embodiments, a connection may include a connector, such as a threaded connector, rail connector, snap connector, adhesive, magnet and/or the like.

According to some aspects of embodiments, a fluid container, compressor vessel, compressor, conduit system, applicator control system and/or portion thereof may be reversibly mechanically releasable. In one aspect of embodiments, for example, a reversibly mechanically releasable connection may allow a container to be exchanged and/or re-filled without substantially damaging a fluid dispenser and/or impacting it's efficiency. In another aspect of embodiments, a mechanical connector which may allow a reversible mechanical releasable connection, for example of a fluid container, may include a Nylon Fitting-Male adapter, a threaded bore, and/or the like. In further aspects of embodiments, a pressure line may include a High Molecular Weight Liner Polyethylene Tee adapter, a conduit system May include a steel clamp, a nozzle may include a snap connector, frictional connector and/or the like.

According to some aspects of embodiments, a fluid dispenser may be configured to be carried by an operator. In one aspect of embodiments, a fluid dispenser may include one or more straps, for example a shoulder strap, a waist strap and/or the like. In another aspect of embodiments, a strap may include any material. In further aspects of embodiments, a strap may include a fiber, polymer, cloth material, and/or the like. In other aspects of embodiments, a strap may include fasteners, for example Velcro®, snap, wrap, belt fasteners and/or the like. As illustrated in some aspects of embodiments in FIG. 1, fluid dispenser 100 may include shoulder strap 102.

According to some aspects of embodiments, a fluid dispenser may include a frame. In one aspect of embodiments, a frame may include a flexible tie and/or belt configured to attach the components of a fluid dispenser. In another aspect of embodiments, a frame may include a bag, for example a compartmentalized cloth bag configured to support the components of a fluid dispenser. In further aspects of embodiments, a frame may include one or more bars, planks, surfaces and/or the like configured to support the components of a fluid dispenser. As illustrated in some aspects of embodiments in FIG. 1, fluid dispenser 100 may include a back-pack frame 104.

According to some aspects of embodiments, a fluid dispenser may be configured to be simultaneously carried and employed by an operator. In one aspect of embodiments, a portable fluid dispenser may be configured to be practically moved and/or practically simultaneously moved and employed irrespective of the environment of operation, for example irrespective of terrain. In another aspect of embodiments, a fluid dispenser may not require wheels. As illustrated in some aspects of embodiments in FIG. 1, fluid dispenser 100 may be configured to be carried by an operator employing strap 102 and/or back-pack frame 104. As illustrated in other aspects of embodiments in FIG. 1, fluid dispenser 100 may be configured to be carried by an operator employing straps 102 and/or frame 104, and/or simultaneously operated by an operator employing conduit system 150, applicator 140 and/or control system 150 irrespective of the environment of operation and/or environment of need.

Embodiments may relate to a process of employing a fluid dispenser. Referring to example FIG. 3, a process may include dispensing and/or applying one or more fluids to a subject 310. In one aspect of embodiments, a process may include applying one or more incompressible fluids to a subject. In another aspect of embodiments, a subject may include a human and/or portion thereof, for example human skin. In further aspects of embodiments, a subject may include a device and/or portion thereof, for example a vehicle. In other aspects of embodiments, a subject may include a urban structure and/or portion thereof, for example a wall, a street and/or the like. In more aspects of embodiments, a subject may include a rural structure and/or portion thereof, for example a lawn, a garden and/or the like.

According to some aspects of embodiments, a process may include dispensing and/or applying a fluid at the point of fluid use and/or fluid need. In one aspect of embodiments, a process may include selecting a fluid for discharge and/or application 320. In another aspect of embodiments, a process may include adjusting a fluid 330, which may include adjusting a fluid flow during application. In further aspects of embodiments, adjustment of a fluid may include regulating flow rate, regulating the amount pressure supplied to the fluid, regulating pulsing of fluid flow, adjusting an applicator and/or the like.

According to some aspects of embodiments, selecting and/or adjusting a fluid may include processing one or more factors 340. In one aspect of embodiments, processing a factor may include employing one or more computer processors, for example one or more processors of a CPU of a fluid dispenser and/or of a device remotely connected the fluid dispenser. In another aspect of embodiments, a remote device may be wirelessly remotely connected, for example include an RFID tag, a Bluetooth component, Wi-Fi component and/or the like. In further aspects of embodiments, information from a user may be input and/or read automatically, for example employing an RFID reader.

According to some aspects of embodiments, for example in a portable skin fluid dispenser, a factor processed may include Sun Protection Factor (SPF), skin tone preference, prior sun damage, risk of subsequent burn damage, cost, water resistance, time of day, skin type, amount of fluid applied, frequency of application, user activities, and/or amount of fluid absorbed on the skin. In another aspect of embodiments, for example in a portable paint fluid dispenser, a factor processed may include color, shine, corrosion, number of coatings, wear and/or the like. In further aspects of embodiments, for example in a portable cleaning fluid dispenser, a factor may include corrosion, wear, number of coatings and/or the like. In other aspects of embodiments, for example in a portable weed control fluid dispenser, a factor may include the speed of weed growth, amount of weed growth, irrigation and/or the like. In more aspects of embodiments, selecting and/or adjusting a fluid, for example at the point of use and/or point of need, may maximize tailoring a property of a fluid to substantially match it's use to reach a desired effect.

Referring to example FIG. 4 and FIG. 5, a fluid dispenser is illustrated in accordance with some aspects of embodiments. In some aspects of embodiments, fluid dispenser 400 may include compressor vessel 410. In one aspect of embodiments, compressor vessel 410 may be configured to house a fluid, for example a compressible fluid which may be compressed. As illustrated in some aspects of embodiments in FIG. 5, compressor vessel 410 may include a pressure tank, such as a DOT-3AL-3000 aluminum diving tank (e.g., TC-3ALM-207), which may include pressure regulator 415.

According to some aspects of embodiments, fluid discharger 400 may include fluid containers 420a, 420b, . . . 420z. In some aspects of embodiments, pressure tank 410 may be configured to fluidly connect with fluid containers 420a, 420b, . . . 420z. In one aspect of embodiments, pressure tank 410 may include pressure output port 412, which may be configured to be connected to shared, pressure line 414. In another aspect of embodiments, regulator 415 may be disposed between pressure output port 412 and shared pressure line 414, which may be configured to modulate the pressure of compressed air (e.g., approximately 25 psi). In further aspect of embodiments, regulator 415 may include turn dial 417, which may modulate the working pressure of a compressed fluid housed in pressure tank 410.

According to some aspects of embodiments, pressure lines 416a, 416b, . . . 416z may each be connected to shared pressure line 414 at one end and/or to pressure input ports 422a, 422b, . . . 422z of fluid containers 420a, 420b, . . . 420z, respectively, at the other end. In one aspect of embodiments, pressure lines 416a, 416b, . . . 416z may be mechanically releasably connected employing a mechanical connector, for example a High Molecular Weight Liner Polyethylene Tee adapter manufactured by U.S. Plastic Corp. In embodiments, pressure lines may include any composition, geometry and/or dimension, for example reinforced poly-vinyl chloride tubing including a length between approximately two feet and 2 inches. In another aspects of embodiments, pressure lines 416a, 416b, . . . 416z may include pressure line valves 418a, 418b, . . . 418z, respectively, which may be configured to modulate flow of compressed air. In embodiments, a valve may include an n-way valve, for example a 2-way poly-vinyl chloride ball valve.

According to some aspects of embodiments, fluid containers 420a, 420b, . . . 420z may be configured to house a fluid, for example a topical product such as sunscreen, sunblock, bronzer, artificial tanner, moisturizer, gel, lotion and/or the like. In one aspect of embodiments, fluid containers 420a, 420b . . . 420z may include a canister, for example a poly-vinyl chloride canister in the approximate shape of a cylinder. In another aspect of embodiments, a canister may include any dimension, for example a diameter of approximately 3 inches and/or a length of approximately 10 inches. In further aspects of embodiments, a canister may be connected to canister caps at it's ends, which may include fixed connections, for example employing adhesive, and/or mechanically releasable connection, which may include threads.

According to some aspects of embodiments, a fluid container may include one or more bores configured to modularly receive one or more modular adapters, and/or may be manufactured to include one or more molded adapters formed by, for example, a molding process. In one aspect of embodiments, any adapter geometry and/or dimension may be employed. In another aspect of embodiments, an approximate quarter inch Nylon Fitting-Male adapter manufactured by U.S. Plastic Corp. may he employed. In further aspects of embodiments, an adapter may include an angled adapter, for example a ninety degree adapter.

According to some aspects of embodiments, one or more washers may be employed. In one aspect of embodiments, any washer geometry and/or dimension may be employed, for example an approximate quarter inch rubber adapter, an approximate quarter inch stainless steel washer and/or the like. In another aspect of embodiments, a bore may be employed to connect a fluid container to a pressure line and/or to a fluid line, for example through an adapter. In further aspects of embodiments, a bore may be mechanically reversibly plugged to re-fill a fluid dispenser. As illustrated in some aspects of embodiments in FIG. 4, pressure input ports 422a, 422b, . . . 422z and/or pressurized fluid output port 424a, 424b, . . . 424z may include an approximate quarter inch nylon fitting-male adapter, an approximate quarter rubber washer and an approximate quarter inch stainless steel washer. As illustrated in other aspects of embodiments in FIG. 4, fluid containers 420a, 420b, . . . 420z may include bores mechanically releasably sealed by plugs 423a, 423b, . . . 423z.

According to some aspects of embodiments, fluid dispenser 400 may include conduit system 430. In some aspects of embodiments, a conduit system may include one or more fluid lines, one or more manifolds and/or one or more dispensing heads. In one aspect of embodiments, one or more portions of a conduit system may be described in U.S. Pat. No. 4,986,449 to Valuyee et al., incorporated by reference herein in its entirety. Such components may include Wunder-Bar® portions, for example a Wunder-Bar® dispensing head, Wunder-Bar® manifold, Wunder-Bar® control system, and/or the like.

According to some aspects of embodiments, conduit system 430 may be configured to fluidly connect to fluid containers 420a, 420b, . . . 420z. In some aspects of embodiments, fluid lines 432a, 432b, . . . 432z, and/or respective outlet portions thereof, may be isolated, unconnected, disconnected, spaced apart and/or detached from an outlet portion of another fluid line. In one aspect of embodiments, fluid containers 420a, 420b, . . . 420z may include pressurized fluid output ports 424a, 424b, . . . 424z, respectively, configured to be connected to fluid lines 432a, 432b, . . . 432z of conduit system 430, which may be isolated from each other.

According to some aspects of embodiments, a fluid line may include any composition, geometry and/or dimension. In one aspect of embodiments, a fluid line may be a reinforced poly-vinyl chloride tubing including a length between approximately two inches and eighteen inches. In another aspect of embodiments, a fluid line may be connected to a manifold, for example and Wunder-Bar® manifold. In another aspect of embodiments, any connector may be employed to connect a fluid line and a manifold. In further aspects of embodiments, a connector may include a stainless steel horse clamp. As illustrated in some aspects of embodiments in FIG. 4, each fluid line 432a, 432b, . . . 432z of conduit system 430 may be configured to fluidly connect to corresponding pressurized fluid output ports 424a, 424b, . . . 424z at one end, and/or to corresponding manifold ports 435a, 435b, . . . 435g of manifold 433 at the other end.

According to some aspects of embodiments, fluid dispenser 400 may include one or more applicators 440. In one aspect of embodiments, fluid lines 432a, 432b, . . . 432z may isolatedly extend to applicator 440. In another aspect of embodiments, fluid lines 432a, 432b, . . . 432z may include isolated fluid tubes disposed in flexible line housing 437 extending from manifold 433 toward applicator 440.

According to some aspects of embodiments, a portion of a conduit system may be disposed in a housing, for example dispensing head 451. In one aspect of embodiments, a portion of a conduit system may be connected with a portion of an applicator through a housing, for example a dispensing head. In another aspect of embodiments, a portion of a conduit system disposed in a housing may be fluidly connected to an applicator portion by any attachment, for example by frictional attachment with an O-ring between a housing and a nozzle. As illustrated in some aspects of embodiments in FIG. 4, a portion of a conduit system 430 may be fluidly connected with a portion of an applicator 400 through dispensing head 451.

According to some aspects of embodiments, applicator 400 may include an output fluid line disposed in a cavity if an applicator. In one aspect of embodiments, a cavity may be filled, for example employing an adhesive, a sealant and/or the like. In another aspect of embodiments, an output fluid line may include any composition, geometry and/or dimension. In further aspects of embodiments, an output fluid line may include an approximate two inch long connector rod. In more aspects of embodiments, an output fluid line include a molded pathway in an applicator portion, for example one or more molded pathways in a nozzle formed in a molding process.

According to some aspects of embodiments, an output fluid line may be configured to he in direct fluid communication with an outlet portion of a fluid line. In another aspect of embodiments, a direct fluid communication may include a fluid pathway through an applicator and not through a closed fluid line. As illustrated in some aspects of embodiments in FIG. 4, an output fluid line disposed in applicator 440 may be configured to be in direct fluid communication with an outlet portion of each fluid line 432a, 432b, . . . 432z of a conduit system disposed in housing 451.

According to some aspects of embodiments, applicator 440 may include a spray nozzle. In one aspect of embodiments, an output fluid line of an applicator may be disposed in a spray nozzle. In another aspect of embodiments, an output fluid line of an applicator may be connected with a sprayer tip. As illustrated on some aspect of embodiment in example FIG. 4, spray nozzle 440 may include an output fluid line which may be connected to sprayer tip 444 at one end and/or which may be in direct fluid communication with fluid lines 432a, 432b, . . . 432z at the other end.

According to some aspects of embodiments, fluid dispenser 400 may include control system 450. In one aspect of embodiments, a control system may be configured to control the flow of a fluid through a fluid line. In another aspect of embodiments, a portion of a control system may be disposed on a housing, for example a dispensing head. In further aspects of embodiments, a housing may be configured to be operated while detached from a frame of fluid dispenser. In more aspects of embodiments, a detachable housing may freely move in any coordinate and/or plane. As illustrated in one aspect of embodiments in FIG. 4, control system 450 may be disposed on dispensing head 451, which may house a portion of conduit system 400 (e.g., portion of fluid lines 432a, 432b, . . . 432g). As illustrated in other aspects of embodiments in FIG. 4, control system 450 may include push-button controls 452, which may select and/or allow the flow of fluid from fluid lines 432a, 432b, . . . 432g.

According to some aspects of embodiments, an uncompressed fluid may be forced, moved and/or actuated through a fluid line of a conduit system by a compressed fluid.

In one aspect of embodiments, a fluid may be pressurized by a compressible fluid. In another aspect of embodiments, a fluid may be actuated through a fluid line by a force supplied by a fluid, for example a substantially constant force. In further aspects of embodiments, a fluid may be actuated and/or pressurized by any suitable pressure, for example employing a pressure of approximately 25 psi supplied by a fluid. As illustrated in some aspects of embodiments in FIG. 4, a fluid housed in fluid containers 420a, 420b, . . . 420z which may be pressurized by the fluid housed in compressor vessel 410, may be actuated through fluid lines 432a, 432b, . . . 432z by the force supplied by the fluid housed in pressure tank 410. As illustrated in other aspects of embodiments in FIG. 4, fluid 460 may be forced out through spray tip 444, and/or may be substantially unmixed and/or may include a substantially constant flow rate.

According to some aspects of embodiments, fluid dispenser 400 may be configured to be carried by an operator. As illustrated in some aspects of embodiments in FIG. 4, fluid dispenser 400 may include shoulder strap 402. In other aspects of embodiments, a fluid dispenser may include a frame. In one aspects of embodiments, a frame and/or portion thereof may include any composition, geometry and/or dimension. In another aspect of embodiments, a frame may include a plastic frame. As illustrated in some aspects of embodiments in FIG. 1, fluid dispenser 400 may include a back-pack frame 404.

According to some aspects of embodiments, fluid dispenser 400 may be configured to be carried by an operator, and/or simultaneously carried and employed by an operator. As illustrated in some aspects of embodiments in FIG. 4, fluid dispenser 400 may be configured to be carried by an operator employing strap 402 and/or back-pack frame 404. As illustrated in other aspects of embodiments in FIG. 4, fluid dispenser 400 may be configured to be carried by an operator employing straps 402 and/or frame 404, and/or simultaneously operated by an operator employing conduit system 450, applicator 440 and/or control system 450 irrespective of the environment of operation and/or environment of need.

According to some aspects of embodiments, a process may include employing fluid dispenser 400 in a process including dispensing and/or applying one or more fluids to a subject. In one aspect of embodiments, a process may include applying one or more incompressible fluids to a human, a device, an urban structure, a rural structure and/or the like. In another aspect of embodiments, a process may include dispensing and/or applying a fluid at the point of fluid use and/or fluid need. In further aspects of embodiments, a process may include selecting a fluid for discharge and/or application. In other aspects of embodiments, a process may include adjusting a fluid, which may include adjusting a fluid flow during application. In more aspects of embodiments, adjustment of a fluid may include regulating flow rate, regulating the amount pressure supplied to the fluid, regulating pulsing of fluid flow, adjusting an applicator and/or the like. As illustrated in some aspects of embodiments in FIG. 4, fluid dispenser 400 may be employed in a process including dispensing and/or applying a fluid housed in fluid containers 420a, 420b, . . . 420z.

According to some aspects of embodiments, selecting and/or adjusting a fluid may include processing one or more factors. In one aspect of embodiments, processing a factor may include employing one or more computer processors. In another aspects of embodiments, for example in a portable skin fluid dispenser, a factor processed may include Sun Protection Factor (SPF), skin tone preference, prior sun damage, risk of subsequent burn damage, cost, water resistance, time of day, skin type, amount of fluid applied, frequency of application, user activities, and/or amount of fluid absorbed on the skin. In further aspects of embodiments, a factor may include user input.

According to some aspects of embodiments, for example in a portable paint fluid dispenser, a factor processed may include color, shine, corrosion, number of coatings, number of fluids, wear and/or the like. In further aspects of embodiments, for example in a portable cleaning fluid dispenser, a factor may include corrosion, wear, number of coatings, number of fluids and/or the like. In other aspects of embodiments, for example in a portable weed control fluid dispenser, a factor may include the speed of weed growth, amount of weed growth, irrigation, number of fluids and/or the like. In more aspects of embodiments, selecting and/or adjusting a fluid, for example at the point of use and/or point of need, may maximize tailoring a property of a fluid to substantially match it's use to a desired effect.

In this specification, “a” and “an” and similar phrases are to be interpreted as “at least one” and “one or more.” References to “an” embodiment in this disclosure are not necessarily to the same embodiment. In this specification, like numerals may reference like elements.

While various embodiments have been described above, it should be understood that they have been presented by way of example, and not limitation. It will be apparent to persons skilled in the relevant art(s) that various changes in form and detail can be made therein without departing from the spirit and scope. In fact; after reading the above description, it will be apparent to one skilled in the relevant art(s) how to implement alternative embodiments. Thus, the present embodiments should not be limited by any of the above-described exemplary embodiments.

As one non-limiting example, it should be noted that the above explanation has focused on the example(s) such as a fluid dispenser including a common pressure line. However, one skilled in the art will recognize that embodiments of the invention could include isolated pressure lines, for example extending from isolated compressor vessels and/or isolated ports of a single compressor vessel. As another non-limiting example, one skilled in the art would recognize that units and/or measurement described herein are intended to be approximations, and where not expressly stated as an approximation are intended to be for illustrative purposes only. Furthermore, any measurement and/or composition of portions of a fluid dispenser are intended to be for illustration purposes, and may include any desired composition and/or dimension, for example of bores, washers, lines, containers, tanks, nozzles, applicators and/or portions thereof In a further example, one skilled in the art will recognize from review of the description and figures, that any portion of a fluid dispenser may he configured to be connected with any other portion of a fluid dispenser, for example two connected fluid containers, a control system and a compressor tank, regulator and/or the like.

As another example, one skilled in the art will recognize that examples of compositions are not intended to be limited, and any material such as a polymer and/or steel may be understood to include any polymer, for example polyethylene, polyvinyl chloride, polystyrene, Teflon, and/or steel may be a non-limiting form of a metal composition that may be employed. As a final example, one skilled in the art will recognize a CPU may be employed, for example of a programmable logic as described in U.S. patent application Ser. No. 12/252,337, incorporated by reference herein in its entirety.

In addition, it should be understood that any figures that highlight any functionality and/or advantages, are presented for example purposes only. The disclosed architecture is sufficiently flexible and configurable, such that it may be utilized in ways other than that shown. For example, the steps described and/or the data flow listed in any figures may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A device comprising:
a. a plurality of fluid containers;
i. each of said plurality of fluid containers configured to house a liquid; and
ii. at least, one of said plurality of fluid containers comprising a bag;
b. a pressure tank:
i. configured to house compressed air;
ii. including a regulator configured to modulate the working pressure of said compressed air; and
iii. a pressure line:
1. configured to fluidly connect to:
a. said regulator; and
b. each of said plurality of fluid containers; and
2. including a valve configured to modulate the flow of said compressed air;
c. a conduit system comprising a plurality of fluid lines, each of said plurality of fluid lines:
i. configured to fluidly connect to one of said plurality of fluid containers; and
ii. including an outlet portion disposed in a Wunder-Bar® dispensing head, said dispensing head comprising a push-button control system;
d. an applicator:
i. connected to said dispensing head;
ii. fluidly connected to each of said plurality of fluid lines; and
iii. including a sprayer tip; and
e. an operator support structure comprising at least one of:
i. a back-pack frame; and
ii. a strap; and
f. wherein:
i. said fluid is:
1. selected employing said control system; and
2. actuated by a force supplied by said air through:
a. each of said plurality of fluid lines and corresponding outlet portion; and
b. said sprayer tip; and
ii. said device is configured to be simultaneously carried and operated by an operator.

2. A device comprising:
(a) a plurality of fluid containers;
1) each of said plurality of fluid containers configured to house an incompressible fluid; and
2) at least one of said plurality of fluid containers comprising a bag;
(b) a compressor vessel configured to:
1) fluidly connect to each of said plurality of fluid containers; and
2) house a compressible fluid;
(c) a conduit system comprising a plurality of fluid lines, each of said plurality of fluid lines:
1) configured to fluidly connect to one of said plurality of fluid containers; and
2) including an outlet portion,
(d) wherein said fluid is actuated through each of said plurality of fluid lines and out of said outlet portion by a force supplied by said compressible fluid.

3. The device of claim 2, further comprising an applicator including a spray nozzle fluidly connected to said outlet portion of each of said plurality of fluid lines.

4. The device of claim 3, wherein said spray nozzle includes an output fluid line:
(a) disposed in a cavity of said spray nozzle; and
(b) connected to a sprayer tip.

5. The device of claim 2, further comprising a control system configured to control the flow of said fluid through each of said plurality of fluid lines.

6. The device of claim 5, wherein said control device comprises a plurality of push-button controls configured to control the flow of said fluid through each of said plurality of fluid lines.

7. The device of claim 2, further comprising a Wunder-Bar® dispensing head.

8. The device of claim 7, wherein a portion of said conduit system is disposed in said dispensing head.

9. The device of claim 2, further comprising a support structure including at least one of:
(a) a back-pack frame; and
(b) a strap.

10. The device of claim 9, wherein said strap comprises at least one of
(c) a shoulder strap; and
(d) a waist strap.

11. The device of claim 2, wherein said device is configured to be simultaneously:
(a) carried by an operator; and
(b) employed by the operator.

12. The device of claim 2, wherein at least one of said plurality of containers is reversibly mechanically releasable.

13. The device of claim 2, wherein said compressor vessel comprises a pressure tank. unconnected to a compressor.

14. The device of claim 13, wherein said pressure tank comprises a diving tank including a regulator.

15. The device of claim 14, wherein said fluid is actuated through each of said plurality of lines and out of said outlet portion employing a pressure of approximately 25 psi supplied by said compressible fluid.

16. The device of claim 2, wherein said compressor vessel comprises a receiver vessel connected to a portable electrically powered compressor.

17. The device of claim 2, wherein:
(a) at least one of said incompressible fluid comprises a liquid including one of
a. sunscreen;
b. sunblock;
c. bronzer; and
d. artificial tanner; and
(b) said compressible fluid comprises compressed air.

18. A process comprising applying at least one of said incompressible fluid to a subject employing the device of claim 2.

19. The process of claim 18, wherein the process includes at least one of the following:
(a) selecting said at least one incompressible fluid; and
(b) adjusting said at least one incompressible fluid.

20. The process of claim 19, wherein at least one of said selecting and said adjusting comprises processing at least one factor, said at least one factor including at least one of the following:
(a) Sun Protection Factor (SPF);
(b) user skin tone preference;
(c) prior user sun damage;
(d) risk of subsequent burn damage to a user;
(e) cost;
(f) water resistance;
(g) time of day;
(h) user skin type;
(i) amount of fluid applied;
(j) frequency of fluid application;
(k) user activities; and
(l) amount of fluid absorbed on user skin.
